(19) United States
(12) Patent Application Publication
(10) Pub. No.: US 2026/0138893 A1
(43) Pub. Date: May 21, 2026

(54) SYSTEM AND METHOD OF PURIFICATION AND SEPARATION OF SOLIDS IN LIQUIDS BY MEANS OF AQUEOUS FILMS

(71) Applicant: BUBBLETECH LLC, WILMINGTON, DE (US)

(72) Inventor: Ruben Ramos De La Fuente, MEXICO CITY (MX)

(21) Appl. No.: 19/333,902

(22) Filed: Sep. 19, 2025

(30) Foreign Application Priority Data
Sep. 20, 2024 (MX) MX/A/2024/011554

(51) Int. Cl. C02F 1/08; C02F 1/04; C02F 1/68; C02F 103/08; C02F 103/32

(52) U.S. Cl. CPC C02F 1/08; C02F 1/043; C02F 1/68; C02F 2103/08; C02F 2103/32; C02F 2201/004; C02F 2301/026

(57) ABSTRACT

A system of purification and separation of solids in liquids by means of aqueous films is provided, comprising a hermetically sealed container tube comprising front and rear caps, wherein said front cap comprises an air inlet duct and said rear cap comprises an air and clean steam outlet duct; a room temperature condenser; wherein said container tube comprises inside a pair of front and rear supports, wherein the front support comprises a front rotary system; a rotary contactor that is rotated by said rotary system, which comprises a plurality of three-dimensional meshes, configured for the formation of aqueous membranes or films in upper, lower and lateral openings thereof; and a central blowing chamber; an air conduction duct with an air inlet section and an air expulsion section to constantly expel air by means of a plurality of expulsion nozzles; a mirror for mixing liquid to be treated with a surfactant and with a temperature between 50-60° C., wherein said mirror has a depth of ⅓ of the diameter of the container tube; and a clean vapor concentration space; wherein the air expelled by the expulsion nozzles breaks up the films of mixture of liquid to be treated and surfactant, formed in the three-dimensional meshes, wherein the breaking up of said aqueous films causes the formation of said clean vapor, which is maintained in the concentration space and the solids contained in said aqueous films fall to the bottom of the container tube for subsequent treatment; and wherein the air pressure, once it breaks up said aqueous films, continues its path, conducting the clean vapor towards the air outlet duct and towards the condenser through said distribution pipe to condense said clean vapor and convert it to its liquid state for extraction, at a temperature between 10-20° C.

### RELATED APPLICATION

This application claims priority to Mexico Patent Application No. MX/a/2024/011554, filed Sep. 20, 2024. The entire contents of which is incorporated herein by reference.

### TECHNICAL FIELD OF THE INVENTION

The present invention is directed to the industrial sector of liquid purification by evaporation. Specifically, the invention refers to a system and process for the purification and separation of solids in liquids by means of aqueous films, which is capable of treating complex liquids with more dissolved solids in a single step, at atmospheric pressure, low evaporation temperature, and a condensation temperature of between 10 to 20° C., achieving a high separation efficiency of up to 99.98%.

### BACKGROUND OF THE INVENTION

As is well known in the state of the art, conventional purification processes using temperature-based evaporation for various types of liquids are very inefficient, since they require a large amount of energy to raise the temperature of the liquid to boiling point, thus, maintaining this mass transfer system results in excessively high energy expenditure of evaporated mass. This just by converting this aqueous mass into steam. Therefore, purifying different liquids requires large amounts of energy, and the steam generated at high temperatures carries various contaminants with it.

In this sense, in the state of the art there are different systems and processes for liquid purification, such as reverse osmosis, flash distillation, multi-effect distillation, and vacuum evaporators, among others. However, these type of processes, as mentioned, require high energy consumption, besides requiring filters, high temperatures, vacuum, or low pressure to separate some solids.

For example, in the alcoholic beverage industry, such as beer/beverage production, 2.5-3.5 liters of water are consumed per liter of beverage produced, thus, considerable investments are made in this type of industry to improve water management and minimize wastewater, avoiding wastewater treatment. Likewise, in wastewater treatment, conventional processes have low solids removal efficiency and high operating costs.

In accordance with the above, document CN204447631U is known, which refers to a liquid-propelling device. Wherein, the three-dimensional liquid droplet field and/or the three-dimensional liquid membrane fields distributed in a preset manner can be generated, in other words, at least one of the three-dimensional liquid droplet fields can be orderly distributed in a preset manner and the three-dimensional liquid membrane field can be orderly distributed in a preset state and a preset distribution mode can be generated, so that the purification effects and the like can be realized in a comprehensive, purposeful, effective, and rapid manner. This device merely refers to a device for filtering solids in water by means of small-scale centrifugation, which is completely different to the present invention, which refers to a system for purifying and separating dissolved solids in liquids by fracturing or breaking aqueous films or membranes.

On the other hand, there is the document US2006011062A1, which refers to a system and device used for liquid-gas phase mass transfer with contaminant removal, which include a plurality of liquid membrane producing cells wherein upon contact, the liquid membranes collapse with a gas stream and the collapsed liquid material covers the suspended particles and removes them by decantation. In addition, the membrane cells increase the velocity of the gas stream and cause the gas stream to strike the liquid surface at an angle of incidence of 45°, which serves to improve the transfer of vapor to the gas. This device is also different from the system of the present invention, since although it also separates solids from a liquid by means of liquid membranes, it does so in a different way from the system of the invention since it does not comprise a rotary contactor comprising a plurality of three-dimensional meshes, which are configured for the formation of aqueous membranes or films in upper, lower and lateral openings, nor a condenser that condenses the clean steam and converts it into its liquid state for extraction, at a temperature between 10-20° C., since said document US2006011062A1 only generates steam in the form of dew without condensing it.

Likewise, there is the document EP3388753A1, which refers to a method, device and system, through which the temperature of a liquid can be controlled, through solid surfaces that are humidified and fed by an air flow, as well as acquiring humidity when in contact with a water source, wherein the water source, as well as said surfaces, tend to cool, and in doing so, the same and any equipment subject to the same laws and/or phenomena will lose efficiency due to the change in temperature of the liquids involved in the humidification process. The main difference with this document refers to the fact that in this process the contaminant-free steam, product of the breaking of bubbles, is condensed by any method at atmospheric pressure or not, and at room temperature. However, this device does not include, as part of the same system, a condenser that condenses the clean vapor and converts it to its liquid state for extraction, at a temperature between 1° and 20° C. Nor does it include a rotating contactor with a plurality of three-dimensional meshes configured to form aqueous membranes or films in upper, lower, and side openings, since in document EP3388753A1, the aqueous membranes are formed by a slotted disc.

Finally, there is the document EP3415219A, which refers to a mass transfer system with solids capture by the induction of an electromagnetic field, comprising a plurality of cells formed on a plurality of discs that form a set of membrane and electromagnetic field generating means. The liquid membranes formed in this assembly collapse upon contact with a gas stream. The system also has means for generating an electromagnetic field that are electrically energized to provide an electromagnetic field to the assembly, such that the solids that circulate after the rupture of the liquid membrane are attracted to each disc based on the ionic behavior thereof. The system also has solid capture means that are radially adjusted in the space between discs, and solid extraction means that are adjusted to the capture means to remove or transport the captured solids. The present invention unlike the system disclosed in this document, does not require an electromagnetic field for the separation of solids from the liquid. In addition, it comprises a condenser to condense the clean vapor and convert it to its liquid state at a temperature between 10-20° C. for its extraction and subsequent use, similarly, the system of this document does not comprise a rotating contactor comprising a plurality of three-dimensional meshes, each of which is configured to form aqueous membranes or films in upper, lower, and lateral openings, which optimize the generation of purified liquid.

Therefore, in the state of the art, there is no system of purification and separation of dissolved solids in liquids by means of aqueous films, wherein the breaking of said films causes the separation of the solute by evaporating the central element (solvent) for its subsequent condensation, and which is highly efficient for the purification of complex liquids such as industrial waters in different branches, as well as for desalinating water with a high level of dissolved salts from 50 ppm (parts per million) and up to 90,000 ppm.

### OBJECTS OF THE INVENTION

Is therefore one object of the present invention to provide a system of purification and separation of solids in liquids by means of aqueous films that enables the separation of elements and compounds from the liquid/liquid and solid/liquid by means of aqueous membranes.

Another object of the present invention is to provide a system of purification and separation of solids in liquids by means of aqueous films that is simple, with low energy consumption, and high durability of its components.

A further objective of the present invention is to provide a system of purification and separation of solids in liquids by means of aqueous films that is capable of treating liquids with a high content of salts and dissolved solids with an efficiency of 99.98%, achieving compliance with Mexican Official Standards.

Yet another objective of the present invention is to provide a system of purification and separation of solids in liquids by means of aqueous films that is capable of treating liquids with a high content of salts and dissolved solids in a single step, at atmospheric pressure, at a low temperature for evaporation, and at a temperature between 1° and 20° C. for condensation. It should be noted that the lower the condenser temperature, the higher the energy cost for condensation.

Another object of the present invention is to provide a system of purification and separation of solids in liquids by means of aqueous films capable of treating ultrasaline water up to 90,000 ppm, as well as the stillage derived from the distillation of agave products and other types of water.

### BRIEF DESCRIPTION OF THE INVENTION

These and other objects are achieved through a system of purification and separation of solids in liquids by means of aqueous films, which is formed by a hermetically sealed container tube comprising front and rear caps, configured to house the system components, wherein said front cap comprises an air inlet duct and said rear cap comprises an air and clean steam outlet duct; a condenser at a suitable temperature in fluid communication with the air outlet duct by means of a distribution pipe; wherein said container tube comprises inside a pair of front and rear supports, wherein the front support comprises a front rotary system with two front and rear rowlocks; a rotary contactor that is rotated by said rotary system, which comprises a plurality of circumferential three-dimensional meshes, which are configured for the formation of aqueous membranes or films in upper, lower and lateral openings of said meshes; and a central blowing chamber; an air conduction duct with an air inlet section fluidly connected to said air inlet duct and an air expulsion section to constantly expel air by means of a plurality of expulsion nozzles, which is located inside said blow chamber; a mirror for mixing liquid to be treated with a surfactant and with a temperature between 50-60° C., wherein said mirror has a depth of ⅓ of the diameter of the container tube; and a concentration space of clean vapor formed between the mixing mirror, the rotary contactor and the inner surface of the container tube; wherein the air expelled by the expulsion nozzles breaks the films of mixture of liquid to be treated and surfactant, formed in the three-dimensional meshes, wherein the rupture of said aqueous films causes the formation of said clean vapor, which is maintained in the concentration space and that the solids contained in said aqueous films fall to the bottom of the container tube for subsequent treatment; and wherein the air pressure, once it breaks said aqueous films, continues its path, driving the clean steam toward the air outlet duct and toward the condenser through said distribution pipe to condense said clean steam and convert it into its liquid state for extraction, at a temperature between 10 to 20° C.

The additional features and advantages of the invention should be more clearly understood through the detailed description of the preferred embodiment thereof, given by means of a non-limiting example with reference to the attached drawings, in which:

### BRIEF DESCRIPTION OF THE FIGURES

FIG. 1 is an exploded view of the system of purification and separation of solids in liquids by means of aqueous films of the present invention.

FIG. 2 is a perspective view of the system of purification and separation of solids in liquids by means of aqueous films of the present invention.

FIG. 3 is a side sectional view of the system of purification and separation of solids in liquids by means of aqueous films of the present invention.

FIG. 4 is a cross-sectional view of the system of purification and separation of solids in liquids by means of aqueous films of the present invention, showing the air path.

FIGS. 5A and 5B are detailed views of the three-dimensional meshes of the system of purification and separation of solids in liquids by means of aqueous films of the present invention, with and without aqueous films formed.

FIGS. 6A and 6B are detailed views of the three-dimensional meshes of the system of purification and separation of solids in liquids by means of aqueous films of the present invention, showing the process of breaking up the aqueous films by the air jet.

FIG. 7 is a detailed view of the condenser of the system of purification and separation of solids in liquids by means of aqueous films of the present invention, showing the process of cold condensation of the clean steam to its liquid state.

### DETAILED DESCRIPTION OF THE INVENTION

The main objective of the system of purification and separation of solids in liquids by means of aqueous films of the present invention is to cause liquid/liquid or liquid/solid separation in various types of liquids for the purpose of purification by means of generating steam at low temperatures, from the breaking up of the aqueous films.

This process is highly efficient for purifying complex liquids such as industrial waters in different branches, as well as for desalinating water with a high level of dissolved salts from 50 ppm (parts per million) to 90,000 ppm, as well as the vinasse derived from the distillation of agave products and other types of water.

Therefore, the system of purification and separation of solids of the present invention provides a simple technological purification process, with low energy consumption and high durability of the components that conform the system of the invention where it is implemented, and which has the capacity to treat liquids with a high content of salt and dissolved solids, with an efficiency of 99.98%, achieving compliance with Mexican Official Standards. All of this in a single step, at atmospheric pressure, low evaporation temperature, and an adequate condensation temperature.

Consequently, the system of purification and separation of solids in liquids by means of aqueous films of the present invention is highly efficient in the following processes:
Industrial wastewater treatment plants;
Seawater desalination plants and plants for ultra-salty water rejections from technologies such as reverse osmosis;
Plants for the treatment of water extracted from underground wells with high salinity levels.
Treatment of vinasse derived from the distillation of agave products.

As well as in water treatment in the following industries:
Chemical
Mining
Textile
Food and beverage
Steel
Paper
Municipal

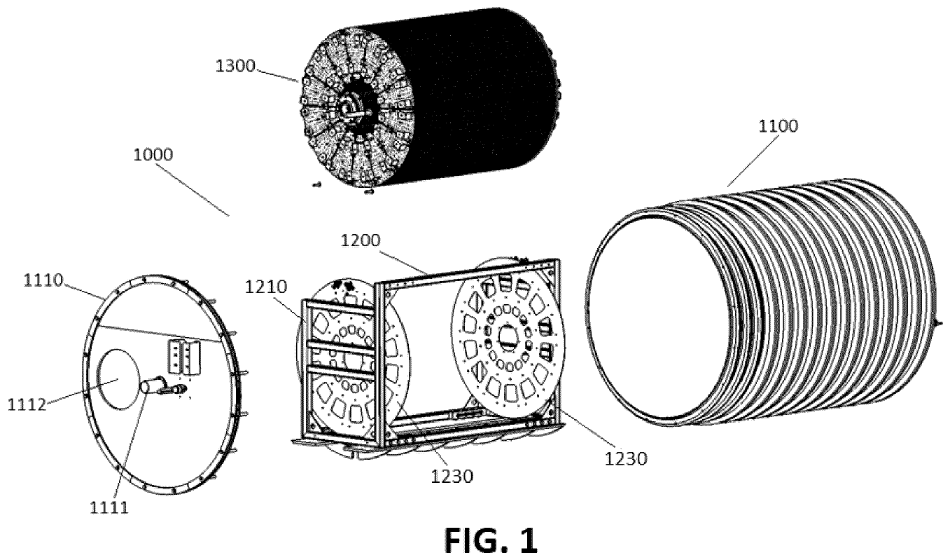

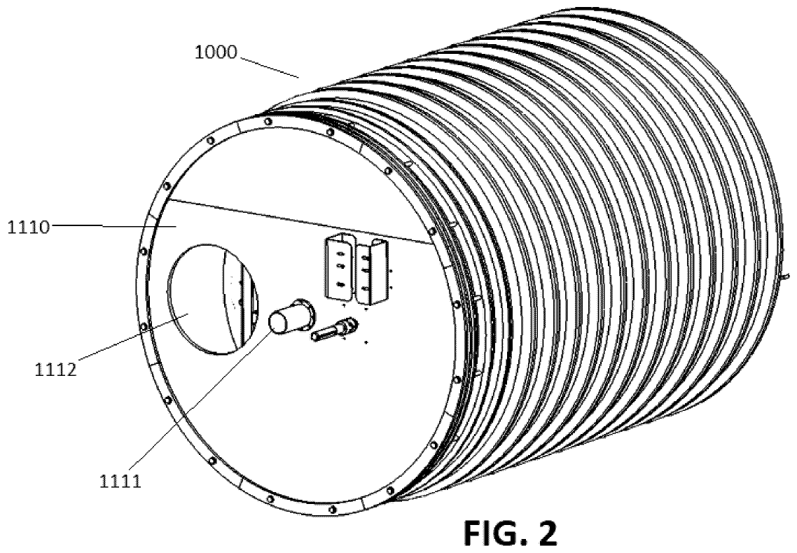

Referring now to FIGS. 1 to 3, the system of purification and separation of solids in liquids by means of aqueous films of the present invention, generally numbered 1000, is shown. Said system of purification and separation of solids 1000 is primarily comprised of a hermetically sealed container tube 1100; an internal support structure 1200; a rotary contactor 1300; a steam distribution pipe 1400; and an external condenser 1500.

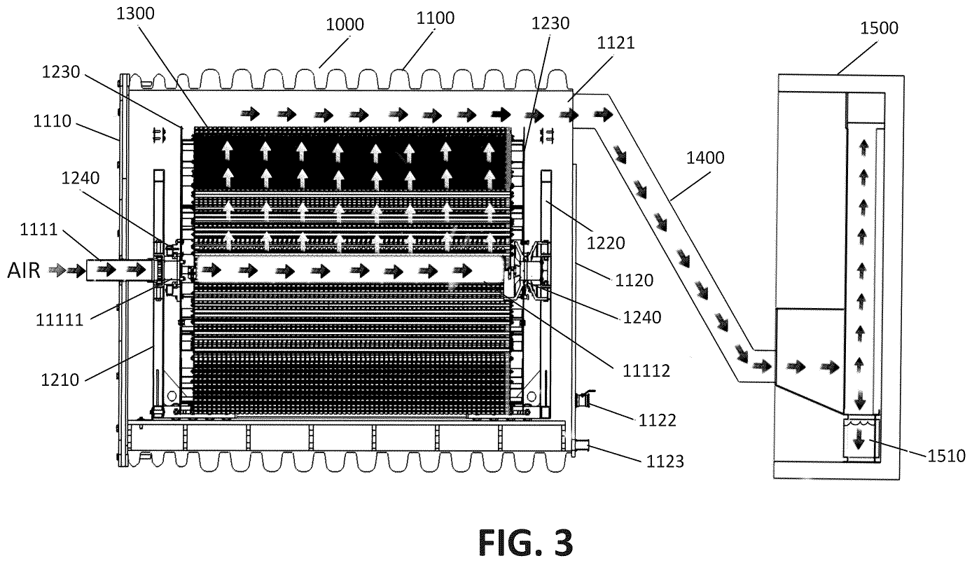

As shown in FIGS. 1 and 3, the container tube 1100 comprises a cylindrical body having a front cap 1110 and a rear cap 1120 configured to removably and hermetically couple to the containment tube 1100, wherein said front cap comprises an air inlet duct 1111; and a window 1112 for accessing the interior of the container tube 1100 for monitoring the same. Said rear cap 1120 in the preferred embodiment comprises a steam outlet 1121 at its top, fluidly connected to the steam distribution pipe 1400; and at its bottom, a feeding connector 1122 of liquid to be treated, through which the liquid to be treated is constantly received from an external tank that maintains said liquid at a temperature between 50-60° C.; and a discharge conduit 1123 for discharging the liquid to be treated or the separated solids for further treatment. According to the previous, it will be evident for a person skilled in the art that the clean steam outlet in an alternative embodiment of the invention is located in the container tube 1100.

Referring again to FIGS. 1 and 3, it can be seen that the internal support structure 1200 comprises a front support 1210 and a rear support 1220 each configured to support a rowlock 1240, which are fixed to a pair of front and rear covers 1230 to rotate the rotary contactor 1300 by means of an external motor (not shown) at a speed between 5 and 10 rpm, wherein said front and rear covers 1230 are respectively connected to the front and rear faces of the rotary contactor 1300.

Referring now to FIGS. 3 to 5B, it is shown that the rotary contactor 1300 is formed by a plurality of three-dimensional meshes 1310 and a central air blowing or expelling chamber 1320. Each of said plurality of three-dimensional meshes 1310 is formed by a network of cubes joined together, with an opening 1311, 1312, 1213 respectively, on each of their faces, which allow the formation of upper, lateral and lower aqueous films PA on the 6 faces of each cube or geometric unit when said three-dimensional meshes 1310 come into contact with a mixture of liquid to be treated-surfactant. Said rotary contactor 1300 further comprises an air conduction duct 1111, which comprises an air inlet section 11111 and an air expulsion section 11112 for expelling air at an average speed of 55-70 km/hr in a constant manner through a plurality of air expulsion nozzles 11113 towards the blowing chamber 1320. Although in the preferred embodiment, the rotary contactor 1300 formed by the plurality of three-dimensional meshes 1310 has a circumferential or cylindrical shape, it will be evident for a person skilled in the art that said contactor may have any polygonal shape, such as hexagonal, octagonal, or the like.

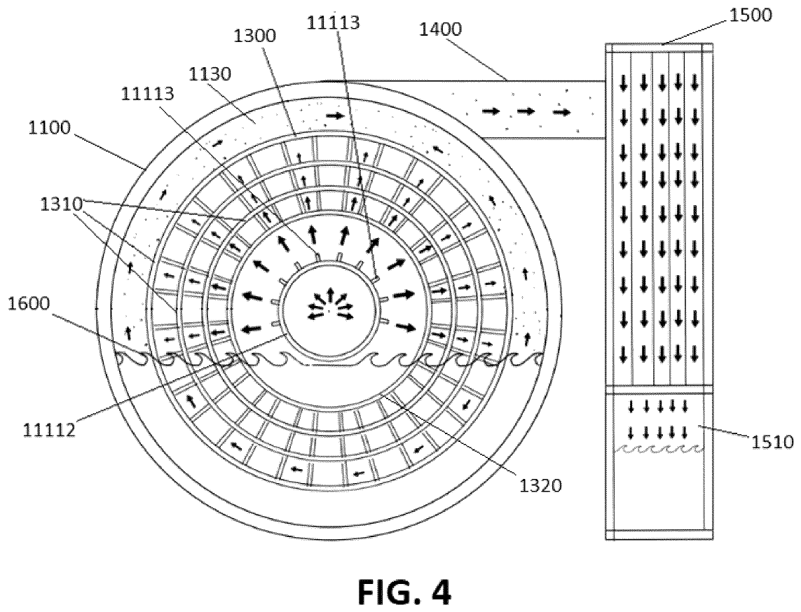

As shown in FIG. 4, to begin the treatment of the liquid to be treated, the container tube 1100 is filled with said liquid to be treated to form a mirror or water depth 1600 with a height of ⅓ of the total height or diameter of the container tube, to said liquid to be treated a surfactant is added to increase the surface tension of said liquid to be treated, wherein the liquid/surfactant ratio depends on the physical-chemical composition of the liquid to be treated, since for example in the desalination of water with 40,000 ppm of salt, a surfactant dosage of 200 ml per 1,000 liters of water has been used. Likewise, in the treatment of vinasse derived from the distillation of agave products, a proportion of 100 ml of surfactant per 1,000 liters is used.

Similarly, depending on the liquid to be treated, the surfactant will be selected, which is selected from conventional surfactants well known in the state of the art, selected from: softened water, polysorbate 20, STEPANBLEND AVV, corn starch, fresh yeast; METHYLISOTHIAZOLINOL, methylene blue.

Referring again to FIGS. 3 and 4, it can be seen that a clean steam concentration space 1130 is formed inside the container tube 1100 between the inner surface of said container tube 1100, the rotary contactor 1300 and the water mirror or water depth 1600, which is configured to contain the clean steam generated by the rupture of the aqueous films PA, and which forms a closed air path circuit with the steam outlet 1121, the blowing chamber 1320, and the steam distribution pipe 1400, so that the same air blown or expelled by the air expulsion nozzles 11113 that breaks the aqueous films PA conducts the clean steam towards the condenser 1500.

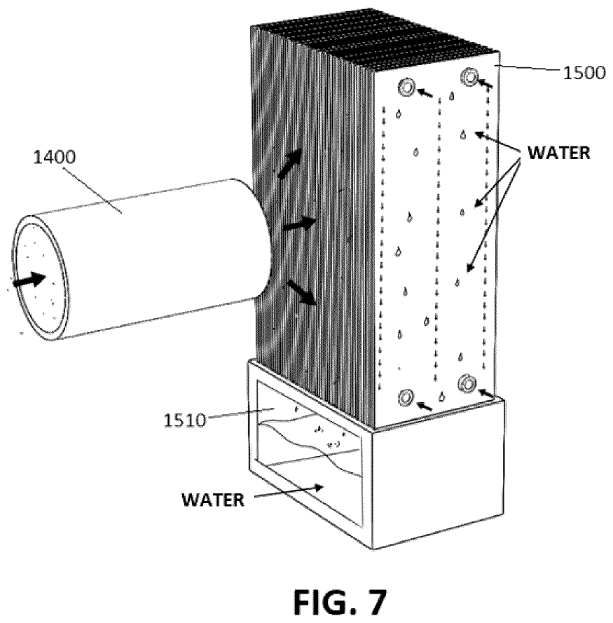

As shown in FIGS. 3, 4 and 7, the condenser 1500 comprises in its lower part a container 1510 to receive the condensed and purified water coming from the container tube and extract it.

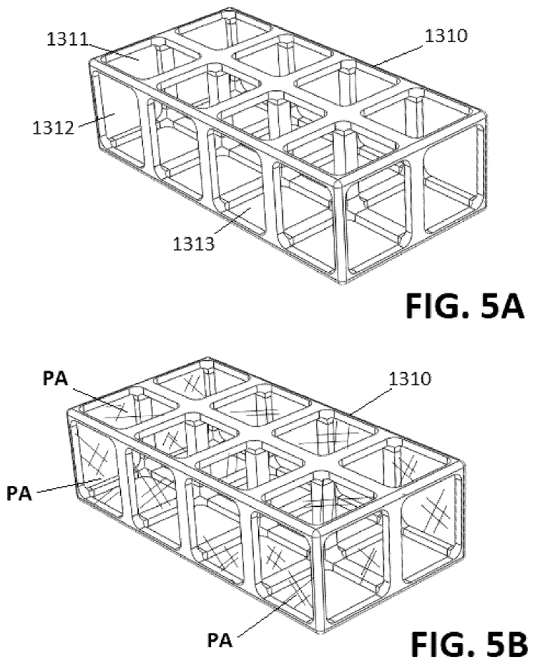

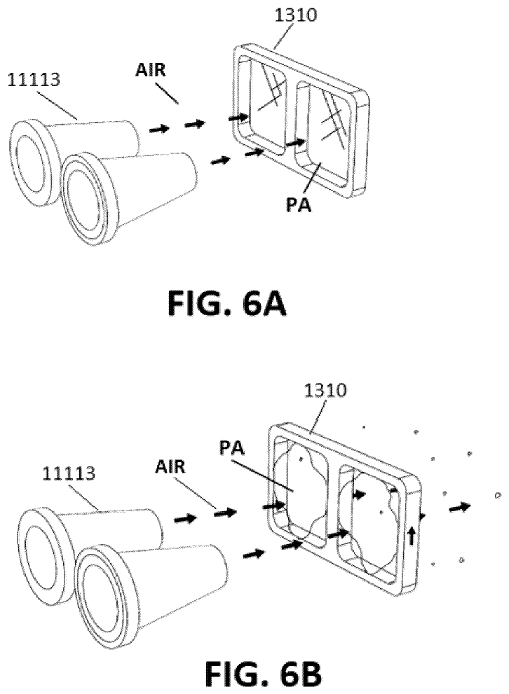

With reference to FIGS. 3 to 7, the formation and breaking up of the aqueous films PA is shown, where said aqueous films PA are formed when the rotary contactor 1300 rotates (considering the clockwise direction) and the three-dimensional meshes 1310 come into contact with the mixture liquid to be treated-surfactant, on the right of the container tube 1100, forming upper, lateral and lower aqueous films on the 6 faces 1311, 1312, 1313 of each cube or geometric unit that forms said three-dimensional meshes 1310 as shown in FIG. 5B, such that as the three-dimensional meshes that were in contact with the mixture of liquid to be treated-surfactant exit the water depth 1600 on the left of the container tube 1100, the air jets expelled by the air expulsion nozzles 11113 begin to break up the aqueous films PA formed, as shown in detail in FIG. 6B, in order to generate clean steam and the solids separation, wherein said clean steam is maintained in the clean steam concentration space 1130 and the solids fall by gravity to the bottom of the container tube 1130 for subsequent treatment. The steam generated by the rupture of said aqueous films PA and contained in the clean steam concentration space 1130 is subsequently conducted by the same jets or air currents towards the condenser 1500 through the closed circuit formed by said clean steam concentration space 1130, steam outlet 1121 and steam distribution pipe 1400 to convert said clean steam to its liquid state to obtain purified liquid in the form of drops, which is maintained in the lower container 1510 of the condenser 1500 either to be pumped for reuse, or for a second process, depending on the requirements of its use. In accordance with the present invention, the aqueous films formed are thin films consisting of a thin layer of liquid trapped between two layers of surfactant molecules (activator), which creates surface tension by sending the solute of the film to the perimeter of the frame that limits and shapes it. The films function in different ways depending on the shape of the frame, and a solute concentration gradient is regularly formed where the highest concentration will be at the periphery, therefore, it is seen that in the aqueous films formed in the three-dimensional meshes a molecular migration takes place, wherein the concentration of the solute is left mostly at the periphery of the frame of the openings and the purest form of the liquid in the center thereof.

On the other hand, in a second aspect, the present invention relates to a process for purifying and separating solids in liquids by means of aqueous films, comprising the steps of:
i) filling the bamboo container tube with the liquid to be treated at a temperature between 50-60° C. up to ⅓ of the height of the container tube;
ii) adding a surfactant (activator) to the liquid to be treated to form a mixture of liquid to be treated-surfactant and to increase the surface tension of the liquid to be treated, wherein the liquid/surfactant ratio depends on the physical-chemical composition of the liquid to be treated;
iii) rotating the rotary contactor at a speed of 5-10 rpm to form aqueous films or membranes in the openings on the six faces of the three-dimensional meshes, when these come into contact with the mixture of liquid to be treated-surfactant, molecular migration occurs in the films or membranes, leaving the solute concentration mostly on their periphery and the purest form of the liquid in the center thereof;
iv) breaking up the aqueous films by means of air currents from the expulsion nozzles to form clean steam and separate the solids from the mixture, which fall by gravity to the bottom of the container tube, keeping the clean steam in the clean steam concentration space;
v) conducting the clean steam to the condenser by means of said air currents and through a closed circuit in fluid communication with the distribution duct; and
vi) condensing the clean steam from the container tube in the condenser, which has a temperature between 10-20° C., to convert said steam to its liquid state for extraction.

In light of the above, it will be evident for a person skilled in the art that the membranes or aqueous films formed by the system and process of the present invention are created every second, that is to say, the millions of membranes per minute with which the liquid separation process is carried out, avoid the use of filters as in the technologies known in the state of the art, saving periodic filter replacements, that in some technologies are quite costly.

It will also be evident that the present invention is more efficient with water at high salt concentrations than any other technology. It has been certified that this invention can desalinate water up to 90,000 ppm.

Finally, the present invention can produce between 150 and 250 liters/hr of purified liquid.

### EXAMPLES

The following examples used the surfactants indicated in the table below:

| | SURFACTANT | MILIMETERS |
|---|---|---|
| NUMBER | COMPOSITION COMPONENT | PER LITER |
| 1 | SOFTENED WATER | 826.99 |
| 2 | POLYSORBATE 20 | 10.00 |
| 3 | STEPANBLEND AVV | 80.00 |
| 4 | CORNSTARCH | 50.00 |
| 5 | FRESH YEAST | 25.00 |
| 6 | METHYLISOTHIAZOLINONE | 8.00 |
| 7 | METHYLENE BLUE | 0.01 |

| | |
|---|---|
| TOTAL | 1000.00 |

### Example 1: Purification and Separation of Solids from Saline Water, with a Salinity of 84.8% and a Solids Content of 84,000 ppm

The container tube is filled to ⅓ of its total diameter (1500 liters) with hot saline water at a temperature of 56° C., maintaining said temperature; 700 ml of surfactant is added to the water to increase the surface tension of the water; rotating the rotary contactor at a speed of 7.6 rpm to cause the formation of aqueous films on the three-dimensional meshes of the contactor; air currents or jets at an average speed of 60 km/h from the blowing chamber are applied to these aqueous films to break them up and generate clean steam, which remains suspended above the water mirror; the clean steam generated by these air currents and the closed circuit is then sent or conducted to the condenser, which has a temperature of 17.3° C.; the clean steam is condensed to generate purified water in the form of droplets to be collected in the treated water collection container, wherein a volume of 141 liters/hr, with a salinity of 0.02% and a solids content of 2.3 ppm is reached.

### Example 2: Purification and Solids Separation of Saline Water, with a Salinity of 40% and a Solids Content of 40,000 ppm

The container tube is filled to ⅓ of its total diameter (1500 liters) with hot saline water at a temperature of 55° C., maintaining said temperature; 600 ml of surfactant is added to the water to increase the surface tension of the water; rotating the rotary contactor at a speed of 7.6 rpm to induce the formation of aqueous films on the three-dimensional meshes of the contactor; air streams or jets at an average speed of 60 km/hr from the blowing chamber are applied to said aqueous films to break them up and generate clean steam, which remains suspended above the water surface; the clean steam generated by said air streams and the closed circuit is then sent or conducted to the condenser, which has a temperature of 17.9° C.; the clean steam is condensed to generate purified water in the form of droplets to be collected in the treated water collection container, wherein a volume of 141 liters/hr, a salinity of 0.03%, and a solids content of 36 ppm is reached.

### Example 3: Purification and Separation of Solids from Vinasse Derived from Distillation for the Production of Tequila, with a Salinity of 5.5% and a Solids Content of 5,500 ppm

The container tube is filled to ⅓ of its total diameter (1,500 liters); with hot vinasse at a temperature of 56° C., maintaining said temperature; 150 ml of surfactant is then added to the vinasse to increase its surface tension; the rotary contactor is rotated at a speed of 7.6 rpm to cause the formation of aqueous films on the three-dimensional meshes of the contactor; air streams from the plenum blowing chamber are applied to said aqueous films to break them up and generate clean steam, which remains suspended above the vinasse mirror; the average speed of the air exiting the blowing nozzles is 60 km/hr; the clean steam generated by said air streams and the closed circuit is sent to the condenser, which has a temperature of 20° C.; the clean steam is condensed to generate purified vinasse in the form of droplets to be collected in a treated vinasse container, wherein a volume of 145 liters/hr, a salinity of 0.03%, and a solids content of 35 ppm is reached.

In accordance with the previous, it will be evident for a person skilled in the art that the system of purification and separation of solids in liquids by means of aqueous films described above is presented for illustrative purposes only, since a person skilled in the art can make numerous variations to it, as long as it is designed in accordance with the principles of the present invention. As a consequence of the foregoing, the present invention includes all the embodiments that a person skilled in the art can propose based on the concepts contained in the present description, in accordance with the following claims.

1. A system of purification and separation of solids in liquids by means of aqueous films, comprising:
a hermetically sealed container tube comprising front and rear caps, configured to house the system components, wherein said front cap comprises an air inlet duct and said rear cap comprises an air and clean steam outlet duct;
a condenser at a temperature between 10-20° C. in fluid communication with the air outlet duct by means of a distribution pipe;
wherein said container tube comprises inside: a pair of front and rear supports, wherein the front support comprises a front rotary system by means of two front and rear rowlocks;
a rotary contactor that is rotated by said rotary system, which comprises a plurality of circumferential three-dimensional meshes, which are configured for the formation of aqueous membranes or films in upper, lower and lateral openings of said meshes;
a central blowing chamber;
an air conduction duct with an air inlet section fluidly connected to said air inlet duct and an air expulsion section to constantly expel air by means of a plurality of expulsion nozzles, which is located inside said blow chamber;
a mirror or water depth for mixing liquid to be treated with a surfactant having a temperature between 50-60° C., wherein said mirror has a depth of ⅓ of the diameter of the container tube; and
a concentration space of clean vapor formed between the mixing mirror, the rotary contactor and the inner surface of the container tube;
wherein the air expelled by the expulsion nozzles breaks up the films of the mixture of liquid to be treated and surfactant, formed in the three-dimensional meshes, wherein the breaking up of said aqueous films causes the generation of said clean vapor, which is maintained in the concentration space and that the solids contained in said aqueous films fall to the bottom of the container tube for subsequent treatment; and
wherein the air pressure, once it breaks said aqueous films, continues its path, conducting the clean steam toward the air outlet duct and toward the condenser through said distribution pipe to condense said clean steam and convert it to its liquid state for extraction, at a temperature between 10 to 20° C.

2. The system of purification and separation of solids in liquids according to claim 1, wherein it allows liquid/liquid or liquid/solid separation in various types of liquids for the purpose of purification by means of steam generation at low temperatures.

3. The system of purification and separation of solids in liquids according to claim 1, wherein it allows the desalination of water with a high level of dissolved salts from 50 ppm (parts per million) up to 90,000 ppm, as well as the vinasse derived from the distillation of agave products and other types of water.

4. The system of purification and separation of solids in liquids according to claim 1, wherein said front cap additionally comprises an access window to the interior of the container tube for monitoring the same.

5. The system of purification and separation of solids in liquids according to claim 1, wherein said rear cap additionally comprises, in its lower portion, a feeding connector for the liquid to be treated, and a discharge conduit for discharging the liquid to be treated or the separated solids.

6. The system of purification and separation of solids in liquids according to claim 1, wherein the clean steam outlet is located in the container tube.

7. The system of purification and separation of solids in liquids according to claim 1, wherein the rowlocks of said front and rear supports are fixed to a pair of front and rear covers for rotating the rotary contactor, which are respectively connected to the front and rear faces of said contactor.

8. The system of purification and separation of solids in liquids according to claim 1, wherein the air expelled by the plurality of expulsion nozzles is expelled at a constant average speed of 55-70 km/hr.

9. The system of purification and separation of solids in liquids according to claim 1, wherein the surfactant is selected from: softened water, polysorbate 20, STEPANBLEND AVV, corn starch, fresh yeast; METHYLISOTHIAZOLINOL, and methylene blue.

10. The system of purification and separation of solids in liquids according to claim 1, wherein the condenser comprises a container in its lower portion for receiving the condensed and purified water and extracting it.

11. The system of purification and separation of solids in liquids according to claim 1, wherein it allows for a production of between 150 and 250 liters/hr of purified liquid.

12. The system of purification and separation of solids in liquids according to claim 1, wherein the liquid to be treated is selected from saline water, industrial waste water, water extracted from underground wells with high levels of salinity, vinasse derived from the distillation of agave products, as well as water from the Chemical, Mining, Textile, Food and Beverage, Steel, Paper, and Municipal industries.

13. Process for purification and separation of solids in liquids by means of aqueous films, using the system of purification and separation of solids in liquids according to claim 1, comprising the steps of:
i) filling the container tube with liquid to be treated at a temperature of between 50-60° C. up to ⅓ of its diameter;
ii) adding a surfactant (activator) to the liquid to be treated to form a mixture of liquid to be treated-surfactant, and to increase the surface tension of the liquid to be treated, wherein the liquid/surfactant ratio depends on the physical-chemical composition of the liquid to be treated;
iii) rotating the rotary contactor at a speed of 5-10 rpm to form aqueous films or membranes in the openings on the six faces of the three-dimensional meshes, when these come into contact with the liquid to be treated-surfactant mixture, wherein molecular migration occurs in said films or membranes, leaving the solute concentration mostly on their periphery and the purest form of the liquid in the center thereof;
iv) breaking up the aqueous films by means of air currents from the expulsion nozzles to form clean steam and separate the solids from the mixture, which fall by gravity to the bottom of the container tube, and keeping the clean steam in the clean steam concentration space;
v) conducting the clean steam to the condenser by means of said air currents and through a closed circuit in fluid communication with the distribution duct; and
vi) condensing the clean steam from the container tube in the condenser, which has a temperature between 10-20° C., to convert said steam to its liquid state for extraction.

14. The process for purification and separation of solids in liquids according to claim 13, wherein it allows liquid/liquid or liquid/solid separation in various types of liquids by means of steam generation at low temperatures.

15. The process for purification and separation of solids in liquids according to claim 13, wherein it allows the desalination of water with a high level of dissolved salts from 50 ppm (parts per million) up to 90,000 ppm, as well as the vinasse derived from the distillation of agave products.

16. The process for purification and separation of solids in liquids according to claim 13, wherein the air expelled by the plurality of ejection nozzles is expelled at a constant average speed of 55-70 km/hr.

17. The process for purification and separation of solids in liquids according to claim 13, wherein the surfactant is selected from: softened water, polysorbate 20, STEPANBLEND AVV, corn starch, fresh yeast; METHYLISOTHIAZOLINOL, and methylene blue.

18. The process for purification and separation of solids in liquids according to claim 13, wherein it allows a production of between 150 and 250 liters/hr of purified liquid.

19. The process for purification and separation of solids in liquids according to claim 13, wherein the liquid to be treated is selected from saline water, industrial waste water, water extracted from underground wells with high levels of salinity, vinasse derived from the distillation of agave products, as well as water from the Chemical, Mining, Textile, Food and Beverage, Steel, Paper, and Municipal industries.
